(19) United States
(12) Patent Application Publication
(10) Pub. No.: US 2014/0124310 A1
(43) Pub. Date: May 8, 2014

(54) POSITIVE FRICTION POWDER ADDITIVES FOR METALLIC AND NON-METALLIC BRAKE PAD AND BRAKE SHOE FORMULATIONS WITH HIGH AND POSITIVE FRICTION CHARACTERISTIC FOR REDUCING SQUEALING AND MODIFYING FRICTION

(71) Applicant: Kelvin Spencer Chiddick, Maple Ridge (CA)

(72) Inventor: Kelvin Spencer Chiddick, Maple Ridge (CA)

(21) Appl. No.: 13/667,260

(22) Filed: Nov. 2, 2012

(51) Int. Cl. C10M 169/04; C08K 13/04; C08K 3/22; C08K 13/02; F16D 65/04; C08L 71/10

(52) U.S. Cl. 188/251 A; 523/152; 523/155; 523/156; 508/100; 508/108

(57) ABSTRACT

A positive friction powder additive for modifying existing brake pad or brake shoe formulations to reduce squealing associated with braking. The positive friction powder additive comprises a friction modifier and a solid lubricant and is comprised of talc, barytes, aluminum oxide, and molybdenum disulphide. The positive friction powder additive can be formulated with binders and fillers to prepare a non-metallic brake pad or brake shoe formulation and a non-metallic brake pad or brake shoe. The positive friction powder additive, non-metallic brake pad or brake shoe formulation, and non-metallic brake pad or brake shoe have high and positive frictional characteristic which reduces vibrations and noise by reducing stick/slip oscillations by changing friction from negative to positive.

### FIELD OF INVENTION

This invention relates to a novel brake pad or brake shoe formulation and a novel powder additive for modifying existing brake pad and brake shoe formulations to reduce or eliminate the squealing typically associated with braking.

### BACKGROUND

Brake pads and brake shoes are typically comprised of a steel backing plate with a friction modifier compound bound to the surface which faces a disk brake rotor or a brake drum. The friction modifier compound typically comprises metals, such as copper, steel wool, and iron powder, as well as fillers and binders. Certain disadvantages of metallic brake pad and brake shoe formulations relate to environmental concerns, wear, noise, and stopping capability. For example, as a metallic brake pad wears it breaks up into a powder. The resulting metal filings are then washed into nearby water systems and pose environmental risks and challenges.

In addition, when metallic brake pads or brake shoes polish and scuff the brake rotor or drum surface and then get wet and are allowed to stand for a period of time rust tends to form on the surface of the brake rotor or drum and the metallic components of the brake pad or brake shoe. Once the vehicle is set in motion and the brakes are applied at low speed, the brake rotor or drum passes across the face of the brake pad or brake shoe causing a high pitched squeal. This noise is generally attributable to the negative frictional characteristic of the iron oxide that has formed on the brake rotor or drum and the metal in the brake pad or brake shoe.

When the rusted brake rotor or drum slides across the rusted face of the brake pad or brake shoe the friction decreases from a friction coefficient of approximately 0.52 (the “static” friction coefficient of rust (Fe₂O₃) at rest) to approximately 0.28 (the kinetic or “dynamic” friction coefficient of rust (Fe₂O₃) when sliding). This is called negative friction which causes stick/slip oscillations which cause squealing.

The static friction coefficient is a function of time of contact, whereas the dynamic friction coefficient is a function of velocity throughout the range of velocities between two relatively moving bodies. When friction increases with speed, it is characterized as having positive friction. When friction decreases with speed, it is said to have negative friction characteristic. The term “positive friction” will hereinafter refer to the situation where the coefficient of friction increases with the speed of sliding.

For sliding systems with negative friction characteristic, stick/slip oscillations may arise and a squealing and chattering is produced. Many vehicles and transportation systems suffer from squealing or other types of high level noises which cause a nuisance to persons using such vehicles or dwelling close to such systems. Squealing and chattering can be eliminated by, amongst other things, changing the friction characteristic from a negative to a positive one. Friction modifiers are compositions which modify the coefficient of friction between surfaces to which the friction modifier is applied.

The inventor of the present invention has previously reported and described friction modifiers having high and positive friction coefficients (Chiddick et al. U.S. Pat. No. 5,308,516, “Solid Lubricant with High and Positive Friction Characteristic” (1992), Chiddick, U.S. Pat. No. 5,308,516, “Friction Modifiers” (1994), Chiddick, U.S. Pat. No. 6,136,757, “Solid Lubricants and Friction Modifiers for Heavy Loads and Rail Applications”, and Cotter, et al., U.S. Pat. No. 7.045,489, “Friction Control Compositions”), all of which are incorporated herein by reference.

The inventor has recognized a need to replace some or all of the metals in existing brake pads and brake shoes with a novel non-metallic friction modifier with positive friction characteristic. One aspect of the present invention relates to a novel non-metallic brake pad or brake shoe formulation with high and positive friction characteristic for reducing or eliminating the squealing typically associated with braking.

### SUMMARY OF THE INVENTION

In general, the invention relates to a positive friction powder additive wherein the positive friction powder additive can be used to modify existing brake pad and brake shoe compositions. In such applications, the positive friction powder additive comprises a friction modifier and a solid lubricant, such that the coefficient of friction produced between a modified brake pad or brake shoe and a brake rotor or brake drum in sliding contact is greater than 0.50.

The positive friction powder additive preferably comprises at least 90% by weight of the friction modifier and up to 10% by weight of the solid lubricant, wherein 93% by weight of the friction modifier and 7% by weight of the solid lubricant is the preferred formulation.

The friction modifier comprises any combination of aluminum oxide, whiting (calcium carbonate), magnesium carbonate, talc (magnesium silicate), bentonite (natural clay), coal dust (ground coal), barytes (barium sulphate), asbestos (asbestine derivative of asbestos), china clay (aluminum silicate), silica, amorphous silica, naturally occurring silica, slate powder, diatomaceious earth, ground quartz, silica flour, aluminum silicate, zinc stearate, aluminum stearate, magnesium carbonate, white lead, basic lead carbonate, zinc oxide, antimony oxide, dolomite, calcium sulphate, naphthelene synemite, polyethylene fibres, and mica. The preferred friction modifier comprises talc (magnesium silicate), barytes (barium sulphate), and aluminum oxide. The friction modifier has particles with particle sizes in the range of approximately 5 μm to approximately 45 μm.

The solid lubricant comprises molybdenum disulphide, or graphite, or a combination thereof, wherein the preferred solid lubricant is molybdenum disulphide which has particles with particle sizes of approximately 5 μm.

The positive friction powder additive comprises 20% to 80% by weight talc, 10% to 45% by weight barytes, 7% to 57% by weight aluminum oxide, and 2% to 18% by weight molybdenum disulphide, preferably 40% to 60% by weight talc, 15% to 30% by weight barytes, 11% to 26% by weight aluminum oxide, and 4% to 18% by weight molybdenum disulphide. In some cases, the positive friction powder additive comprises 50% to 55% by weight talc, 20% to 25% by weight barytes, 15% to 20% by weight aluminum oxide, and 5% to 10% by weight molybdenum disulphide, preferably 51% by weight talc, 25% by weight barytes, 17% by weight aluminum oxide, and 7% by weight molybdenum disulphide.

In one aspect of the present invention, a non-metallic brake pad or brake shoe formulation comprising a binder, a filler, and a positive friction powder additive can be prepared, such that the coefficient of friction produced between a non-metallic brake pad or brake shoe and a brake rotor or brake drum in sliding contact is greater than 0.50.

The non-metallic brake pad or brake shoe formulation preferably comprises 15% to 20% by weight of the binder, 20% to 30% by weight of the filler, and 50% to 65% by weight of the positive friction powder additive. The binder comprises a phenolic resin, or a polyester, or an epoxy resin powder, or some combination thereof, preferably a phenolic resin. The filler comprises any combination of aluminum oxide, whiting (calcium carbonate), magnesium carbonate, talc (magnesium silicate), bentonite (natural clay), coal dust (ground coal), barytes (barium sulphate), asbestos (asbestine derivative of asbestos), china clay (aluminum silicate), silica, amorphous silica, naturally occurring silica, slate powder, diatomaceious earth, ground quartz, silica flour, aluminum silicate, zinc stearate, aluminum stearate, magnesium carbonate, white lead, basic lead carbonate, zinc oxide, antimony oxide, dolomite, calcium sulphate, naphthelene synemite, polyethylene fibres, and mica, preferably rubber powder, ground cashew nut shells, aluminum oxide, molybdenum disulphide, Kevlar fibre, carbon fibre, and coal coke. The positive friction powder additive is as described above.

The non-metallic brake pad or brake shoe formulation preferably comprises 16% by weight of the binder, 26% by weight of the filler, and 58% by weight of the positive friction powder additive. The binder preferably comprises phenolic resin. The filler preferably comprises rubber powder, ground cashew nut shells, aluminum oxide, molybdenum disulphide, Kevlar fibre, carbon fibre, and coal coke. The positive friction powder additive preferably comprises 51% by weight talc, 25% by weight barytes, 17% by weight aluminum oxide, and 7% by weight molybdenum disulphide.

The non-metallic brake pad or brake shoe formulation preferably comprises 13% to 18% by weight phenolic resin, 1% to 5% by weight rubber powder, 2% to 7% by weight ground cashew nut shells, 2% to 7% by weight aluminum oxide, 1% to 4% by weight molybdenum disulphide, 1% to 4% by weight Kevlar fibre, 2% to 6% by weight carbon fibre, 2% to 7% by weight coal coke, and 52% to 65% by weight of the positive friction powder additive, preferably 16% by weight phenolic resin, 3% by weight rubber powder, 5% by weight ground cashew nut shells, 5% by weight aluminum oxide, 3% by weight molybdenum disulphide, 2% by weight Kevlar fibre, 3% by weight carbon fibre, 5% by weight coal coke, and 58% by weight of the positive friction powder additive as described above.

In another aspect of the present invention, a non-metallic brake pad or brake shoe comprising a backing plate and a friction modifier compound bound to the surface of the backing plate can be prepared, such that the coefficient of friction produced between a non-metallic brake pad or brake shoe and a brake rotor or brake drum in sliding contact is greater than 0.50. The friction modifier compound comprises a binder, a filler, and a positive friction powder additive. The binder, the filler, and the positive friction powder additive are as described above.

The friction modifier compound preferably comprises 13% to 18% by weight phenolic resin, 1% to 5% by weight rubber powder, 2% to 7% by weight ground cashew nut shells, 2% to 7% by weight aluminum oxide, 1% to 4% by weight molybdenum disulphide, 1% to 4% by weight Kevlar fibre, 2% to 6% by weight carbon fibre, 2% to 7% by weight coal coke, and 52% to 65% by weight of the positive friction powder additive, preferably 16% by weight phenolic resin, 3% by weight rubber powder, 5% by weight ground cashew nut shells, 5% by weight aluminum oxide, 3% by weight molybdenum disulphide, 2% by weight Kevlar fibre, 3% by weight carbon fibre, 5% by weight coal coke, and 58% by weight of the positive friction powder additive as described above.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive sense.

One aspect of this invention relates to a non-metallic brake pad or brake shoe formulation, in particular to a positive friction powder additive comprising a solid lubricant and a friction modifier. The positive friction powder additive can be used to modify existing brake pad and brake shoe formulations.

The solid lubricant and the friction modifier can be formulated by selecting one or more solid lubricants and one or more friction modifiers as required. Examples of solid lubricants include, but are not limited to, molybdenum disulphide and graphite. The preferred solid lubricant is molybdenum disulphide. Preferably, the molybdenum disulphide is provided as a powder having particles with particle sizes of approximately 5 μm.

Examples of friction modifiers include, but are not limited to aluminum oxide, whiting (calcium carbonate), magnesium carbonate, talc (magnesium silicate), bentonite (natural clay), coal dust (ground coal), barytes (barium sulphate), asbestos (asbestine derivative of asbestos), china clay (aluminum silicate), silica, amorphous silica, naturally occurring silica, slate powder, diatomaceious earth, ground quartz, silica flour, aluminum silicate, zinc stearate, aluminum stearate, magnesium carbonate, white lead, basic lead carbonate, zinc oxide, antimony oxide, dolomite, calcium sulphate, naphthelene synemite, polyethylene fibres, and mica.

The friction modifier should have a high and positive coefficient of friction. Preferably, the friction modifier comprises a non-metallic powder comprising talc, barytes, and aluminum oxide having particles with particle sizes in the range of about 5 μm to about 45 μm. Talc and barytes are both provided as powders having particles with particle sizes of less than 5 μm. Aluminum oxide is provided as a powder having particles with particle sizes of approximately 44 μm.

The positive friction powder additive comprises about 90% by weight of the friction modifier and about 10% by weight of the solid lubricant, preferably 93% by weight of the friction modifier and 7% by weight of the solid lubricant. In some cases, the positive friction powder additive comprises 20% to 80% by weight of talc, 10% to 45% by weight of barytes, 7% to 57% by weight of aluminum oxide, and 2% to 18% by weight of molybdenum disulphide. Various mixtures were prepared and tested, the positive friction powder additive comprising 40% to 60% by weight talc, 15% to 30% by weight barytes, 11% to 26% by weight aluminum oxide, and 4% to 18% by weight molybdenum disulphide, preferably 50% to 55% by weight talc, 20% to 25% by weight barytes, 15% to 20% by weight aluminum oxide, and 5% to 10% by weight molybdenum disulphide. The preferred positive friction powder additive comprises 51% by weight talc, 25% by weight barytes, 17% by weight aluminum oxide, and 7% by weight molybdenum disulphide.

To improve performance, the positive friction powder additive can be added to most existing brake pad or brake shoe formulations in amounts from at least 10% by weight of the positive friction powder additive to in excess of 65% by weight of the positive friction powder additive, typically less than 65% by weight of the positive friction powder additive, depending on the required friction levels and noise reduction. The positive friction powder additive can be used to replace all of the metal components in existing metallic brake pad and brake shoe formulations to reduce or eliminate rusting of the brake rotor or brake drum and of the brake pad or brake shoe itself, thereby reducing or eliminating squealing. An appropriate amount of binder can be added to the modified brake pad or brake shoe formulation containing the positive friction powder additive in order to allow for any differences in oil absorption between the metals removed and the positive friction powder additive added.

A non-metallic brake pad or brake shoe formulation can be made using the positive friction powder additive as the main friction modifier in the formulation. The positive friction powder additive can be used in combination with powdered binders and fillers, wherein the binders include a phenolic resin, such as Bakelite, or a polyester, or an epoxy powder and the fillers include rubber powder, ground cashew nut shells, aluminum oxide, molybdenum disulphide, Kevlar fibre, carbon fibre, and coal coke.

The non-metallic brake pad or brake shoe formulation preferably comprises 16% by weight of the binder, 26% by weight of the filler, and 58% by weight of the positive friction powder additive. The binder preferably comprises phenolic resin. The filler preferably comprises rubber powder, ground cashew nut shells, aluminum oxide, molybdenum disulphide, Kevlar fibre, carbon fibre, and coal coke. The positive friction powder additive preferably comprises 51% by weight talc, 25% by weight barytes, 17% by weight aluminum oxide, and 7% by weight molybdenum disulphide.

The non-metallic brake pad or brake shoe formulation comprises 13% to 18% by weight phenolic resin, 1% to 5% by weight rubber powder, 2% to 7% by weight ground cashew nut shells, 2% to 7% by weight aluminum oxide, 1% to 4% by weight molybdenum disulphide, 1% to 4% by weight Kevlar fibre, 2% to 6% by weight carbon fibre, 2% to 7% by weight coal coke, and 52% to 65% by weight of the positive friction powder additive, preferably 16% by weight phenolic resin, 3% by weight rubber powder, 5% by weight ground cashew nut shells, 5% by weight aluminum oxide, 3% by weight molybdenum disulphide, 2% by weight Kevlar fibre, 3% by weight carbon fibre, 5% by weight coal coke, and 58% by weight of the positive friction powder additive.

In testing conducted by the inventor, the friction coefficient value of the non-metallic brake pad or brake shoe formulation produced between a non-metallic brake pad or shoe and a brake rotor or brake drum in sliding contact was high and positive, being greater than 0.50. The elimination of negative friction means that the non-metallic brake pad or brake shoe formulation reduces slip/stick oscillation and therefore reduces or eliminates vibrations and noise between the brake pad or brake shoe and the brake rotor or brake drum.

The non-metallic brake pad or brake shoe formulation deposits a thin film of the brake pad or brake shoe material on the brake rotor or brake drum and thereby limits rust forming on the surface of the brake rotor or brake drum and reduces or eliminates the noise associated with braking. The non-metallic brake pad or brake shoe formulation shows reduced brake fade and shows excellent recovery compared to existing metallic brake pads or brake shoes which typically show brake fade. Compared to typical metallic brake pads or brake shoes which require sintering before use and anti-squeal lubricant during use, the non-metallic brake pad or brake shoe formulation does not require sintering or lubrication. The non-metallic brake pad or brake shoe formulation is softer than typical metallic brake pad formulations and, as a result, the non-metallic brake pad or brake shoe formulation reduces brake rotor or brake drum wear compared to a typical metallic brake pad formulation.

Certain properties of brake pad and brake shoe formulations employing the positive friction powder additive are illustrated by comparing the following testing examples.

### EXAMPLE 1

### Typical Metallic Brake Pad Friction Coefficient

The friction characteristic of a typical metallic brake pad was tested by determining the coefficient of friction of the typical metallic brake pad as a function of temperature. The typical metallic brake pad was tested using the Chase test method, which employs a fixed speed friction machine running at 400 RPM. A pressure of 120 lbs. was applied to a 1″ square block test plate of the typical metallic brake pad and the temperature was varied between 100° C. and 300° C. The face of the test plate was badly scored at the end of the test.

TABLE 1
The friction coefficients of the typical metallic brake pad at
temperatures between 100° C. and 300° C.

| | Typical Metallic Brake |
|---|---|
| Temperature (° C.) | Pad Friction Coefficient |
| 100 | 0.36 |
| 150 | 0.37 |
| 200 | 0.36 |
| 250 | 0.36 |
| 300 | 0.34 |

### EXAMPLE 2

### Second Typical Metallic Brake Pad vs. Modified Brake Pad Friction Coefficient

The friction characteristic of a modified brake pad comprising the positive friction powder additive was tested by determining the coefficient of friction of the modified brake pad as a function of temperature. These results were compared to the friction characteristic of a second typical metallic brake pad as determined by the coefficient of friction of the second typical metallic brake pad as a function of temperature.

The modified brake pad was prepared by modifying a typical metallic brake pad formulation. All metallic components were removed from the typical metallic brake pad and replaced with the positive friction powder additive. Approximately 28% of the existing metallic brake pad formulation was removed and replaced with the positive friction powder additive. The positive friction powder additive was comprised of 51% by weight talc, 25% by weight barytes, 17% by weight aluminum oxide, and 7% by weight molybdenum disulphide.

To allow for the differences in oil absorption between the metallic components and the positive friction powder additive the amount of binder had to be increased by 2%. Using the Chase test method, a pressure of 120 lbs. was applied to 1″ square block test plates of each the modified brake pad and the second typical metallic brake pad and the temperature was varied between 100° C. and 300° C.

TABLE 2
The friction coefficients of the second typical metallic brake pad
and the modified brake pad at temperatures between
100° C. and 300° C.

| | Second Typical Metallic | |
|---|---|---|
| | Brake Pad Friction | Modified Brake Pad |
| Temperature (° C.) | Coefficient | Friction Coefficient |
| 100 | 0.35 | 0.54 |
| 150 | 0.35 | 0.56 |
| 200 | 0.34 | 0.55 |
| 250 | 0.34 | 0.53 |
| 300 | 0.36 | 0.52 |

### EXAMPLE 3

### Second Typical Metallic Brake Pad vs. Modified Brake Pad Level of Noise

The levels of noise generated when the second typical metallic brake pad and the modified brake pad slide across the surface of a brake rotor were tested. Further comparative tests were carried out using a dynamometer. The second typical metallic brake pad and the modified brake pad were first independently bedded in on the dynamometer and then brake applications were made at varying temperatures and speeds. When the tests were completed, the rotor was badly scored by the typical metallic brake pad. The modified brake pad left the rotor smooth and without scores or grooves on the face of the rotor. Levels of noise generated during the tests were reduced by the modified brake pad.

TABLE 3
The level of noise generated by the second typical metallic brake
pad and the modified brake pad after being bedded in
on a dynamometer.

| Brake Pad Formulation | Level of Noise (dB) |
|---|---|
| Second Typical Metallic Brake Pad | 64 to 68 |
| Modified Brake Pad | 45 to 48 |

### EXAMPLE 4

### Modified Brake Pad Brake Fade

Brake fade is the reduction in the coefficient of friction when a brake pad or brake shoe and a brake rotor or brake drum heat up under excessive and long, hard braking action (for example, when driving a vehicle down a long steep hill and applying the brakes to stop). The coefficient of friction of a typical metallic brake pad drops as the temperature of the brake pad or brake shoe and the brake rotor or brake drum rises and the brakes feel spongy and soft to the user as a result. The normal response of the user is to pump the vehicle's brake pedal in an attempt to recover braking power.

The braking power of a brake pad modified with the positive friction powder additive was tested by determining the coefficient of friction of the modified brake pad as a function of temperature. A brake fade test was conducted on the modified brake pad at temperatures ranging from 200° C. to approximately 600° C. At 200° C., the modified brake pad had a friction coefficient of 0.52. The friction coefficient dropped only to 0.49 at 600° C. and fully recovered back to 0.52 after only 3 stops when the temperature was still 500° C. Unlike a typical metallic brake pad, the temperature did not need to return to the starting temperature of 200° C. before the friction coefficient had fully recovered.

### EXAMPLE 5

### Non-Metallic Brake Pad or Brake Shoe Formulation

The friction characteristic of a non-metallic brake pad or brake shoe formulation comprising the positive friction powder additive was tested by determining the coefficient of friction of the modified brake pad as a function of temperature. The non-metallic brake pad or brake shoe formulation was prepared comprising 16% by weight of phenolic resin, 3% by weight rubber powder, 5% by weight ground cashew nut shells, 5% by weight aluminum oxide, 3% by weight molybdenum disulphide, 2% by weight Kevlar fibre, 3% by weight carbon fibre, 5% by weight coal coke, and 58% by weight of the positive friction powder additive. The positive friction powder additive was comprised of 51% by weight talc, 25% by weight barytes, 17% by weight aluminum oxide, and 7% by weight molybdenum disulphide.

The coefficient of friction of the non-metallic brake pad or brake shoe formulation as a function of temperature was determined using the Chase test method, which is a fixed speed friction machine running at 400 RPM. A pressure of 120 lbs. was applied to 1″ square block test plates of each the modified brake pad and the second typical metallic brake pad and the temperature was varied between 100° C. and 300° C.

TABLE 4
The friction coefficients of a non-metallic brake pad or
brake shoe formulation at temperatures between
100° C. and 300° C.

| Temperature (° C.) | Friction Coefficient |
|---|---|
| 100 | 0.53 |
| 150 | 0.54 |
| 200 | 0.53 |
| 250 | 0.58 |
| 300 | 0.54 |

As will be apparent to those skilled in the art in light of the foregoing disclosure, many alterations and modifications are possible in the practice of this invention without departing from the spirit and scope thereof. Accordingly, the scope of the invention is to be construed in accordance with the substance defined by the following claims.

What is claimed is:

1. A positive friction powder additive for modifying typical brake pad and brake shoe formulations comprising:
a friction modifier; and
a solid lubricant,
such that the coefficient of friction produced between a modified brake pad or brake shoe and a brake rotor or brake drum in sliding contact is greater than 0.50.

2. The positive friction powder additive according to claim 1, wherein the positive friction powder additive comprises:
at least 90% by weight of the friction modifier; and
up to 10% by weight of the solid lubricant.

3. The positive friction powder additive according to claim 2, wherein the positive friction powder additive comprises:
93% by weight of the friction modifier; and
7% by weight of the solid lubricant.

4. The positive friction powder additive according to claim 3, wherein the friction modifier comprises:
talc (magnesium silicate);
barytes (barium sulphate); and
aluminum oxide.

5. The positive friction powder additive according to claim 4, wherein the solid lubricant comprises molybdenum disulphide, or graphite, or a combination thereof.

6. The positive friction powder additive according to claim 5, wherein the solid lubricant is molybdenum disulphide.

7. The positive friction powder additive according to claim 6, wherein the positive friction powder additive comprises:
20% to 80% by weight talc;
10% to 45% by weight barytes;
7% to 57% by weight aluminum oxide; and
2% to 18% by weight molybdenum disulphide.

8. The positive friction powder additive according to claim 7, wherein the positive friction powder additive comprises:
51% by weight talc;
25% by weight barytes;
17% by weight aluminum oxide; and
7% by weight molybdenum disulphide.

9. The positive friction powder additive according to claim 8, wherein the friction modifier has particles with particle sizes in the range of approximately 5 μm to approximately 45 μm.

10. The positive friction powder additive according to claim 9, wherein the solid lubricant has particles with particle sizes of approximately 5 μm.

11. A non-metallic brake pad or brake shoe formulation comprising:
a binder;
a filler; and
a positive friction powder additive,
such that the coefficient of friction produced between a non-metallic brake pad or brake shoe and a brake rotor or brake drum in sliding contact is greater than 0.50.

12. The non-metallic brake pad or brake shoe formulation, according to claim 11, wherein the non-metallic brake pad or brake shoe formulation comprises:
15% to 20% by weight of the binder;
20% to 30% by weight of the filler; and
50% to 65% by weight of the positive friction powder additive.

13. The non-metallic brake pad or brake shoe formulation according to claim 12, wherein the binder comprises a phenolic resin, or a polyester, or an epoxy powder, or some combination thereof.

14. The non-metallic brake pad or brake shoe formulation according to claim 13, wherein the binder comprises a phenolic resin.

15. The non-metallic brake pad or brake shoe formulation according to claim 14, wherein the filler comprises any combination of aluminum oxide, whiting (calcium carbonate), magnesium carbonate, talc (magnesium silicate), bentonite (natural clay), coal dust (ground coal), barytes (barium sulphate), asbestos (asbestine derivative of asbestos), china clay (aluminum silicate), silica, amorphous silica, naturally occurring silica, slate powder, diatomaceious earth, ground quartz, silica flour, aluminum silicate, zinc stearate, aluminum stearate, magnesium carbonate, white lead, basic lead carbonate, zinc oxide, antimony oxide, dolomite, calcium sulphate, naphthelene synemite, polyethylene fibres, and mica.

16. The non-metallic brake pad or brake shoe formulation according to claim 15, wherein the filler comprises any combination of rubber powder, ground cashew nut shells, aluminum oxide, molybdenum disulphide, Kevlar fibre, carbon fibre, and coal coke.

17. The non-metallic brake pad or brake shoe formulation according to claim 16, wherein the positive friction powder additive comprises:
a friction modifier; and
a solid lubricant.

18. The non-metallic brake pad or brake shoe formulation according to claim 17, wherein the positive friction powder additive comprises:
at least 90% by weight of the friction modifier; and
up to 10% by weight of the solid lubricant.

19. The non-metallic brake pad or brake shoe formulation according to claim 18, wherein the positive friction powder additive comprises:
93% by weight of the friction modifier; and
7% by weight of the solid lubricant.

20. The non-metallic brake pad or brake shoe formulation according to claim 19, wherein the friction modifier comprises:
talc (magnesium silicate);
barytes (barium sulphate); and
aluminum oxide.

21. The non-metallic brake pad or brake shoe formulation according to claim 20, wherein the solid lubricant comprises molybdenum disulphide, or graphite, or a combination thereof.

22. The non-metallic brake pad or brake shoe formulation according to claim 21, wherein the solid lubricant is molybdenum disulphide.

23. The non-metallic brake pad or brake shoe formulation according to claim 22, wherein the positive friction powder additive comprises:
20% to 80% by weight talc;
10% to 45% by weight barytes;
7% to 57% by weight aluminum oxide; and
2% to 18% by weight molybdenum disulphide.

24. The non-metallic brake pad or brake shoe formulation according to claim 23, wherein the positive friction powder additive comprises:
51% by weight talc;
25% by weight barytes;
17% by weight aluminum oxide; and
7% by weight molybdenum disulphide.

25. The non-metallic brake pad or brake shoe formulation according to claim 24, wherein the non-metallic brake pad or brake shoe formulation comprises:
13% to 18% by weight phenolic resin;
1% to 5% by weight rubber powder;
2% to 7% by weight ground cashew nut shells;
2% to 7% by weight aluminum oxide;
1% to 4% by weight molybdenum disulphide;
1% to 4% by weight Kevlar fibre;
2% to 6% by weight carbon fibre;
2% to 7% by weight coal coke; and
52% to 65% by weight of the positive friction powder additive.

26. The non-metallic brake pad or brake shoe formulation according to claim 25, wherein the non-metallic brake pad or brake shoe formulation comprises:
16% by weight phenolic resin;
3% by weight rubber powder;
5% by weight ground cashew nut shells;
5% by weight aluminum oxide;
3% by weight molybdenum disulphide;
2% by weight Kevlar fibre;
3% by weight carbon fibre;
5% by weight coal coke; and
58% by weight of the positive friction powder additive.

27. The non-metallic brake pad or brake shoe formulation according to claim 26, wherein the friction modifier has particles with particle sizes in the range of approximately 5 μm to approximately 45 μm.

28. The non-metallic brake pad or brake shoe formulation according to claim 27, wherein the solid lubricant has particles with particle sizes of approximately 5 μm.

29. A non-metallic brake pad or brake shoe comprising a backing plate and a friction modifier compound bound to the surface of the backing plate, the friction modifier compound comprising:
16% by weight of phenolic resin;
3% by weight of rubber powder;
5% by weight ground cashew nut shells;
5% by weight aluminum oxide;
3% by weight molybdenum disulphide;
2% by weight Kevlar fibre;
3% by weight carbon fibre
5% by weight coal coke; and
58% by weight of a positive friction powder additive such that the coefficient of friction produced between the non-metallic brake pad or brake shoe and a brake rotor or brake drum in sliding contact is greater than 0.50.

30. The non-metallic brake pad or brake shoe, according to claim 29, wherein the positive friction powder additive comprises:
51% by weight talc;
25% by weight barytes;
17% by weight aluminum oxide; and
7% by weight molybdenum disulphide.
